(19) United States
(12) Patent Application Publication
(10) Pub. No.: US 2015/0171493 A1
(43) Pub. Date: Jun. 18, 2015

(54) COOLING SYSTEM FOR BATTERY CELLS

(71) Applicants: Robert Bosch GmbH, Stuttgart (DE); Samsung SDI Co., Ltd., Yongin-si, Gyeonggi-do (KR)

(72) Inventors: Christian Freese, Stuhr (DE); Xiaofeng Yan, Weinstadt (DE); Christian Pankiewitz, Stuttgart (DE)

(73) Assignees: Robert Bosch GmbH, Stuttgart (DE); Samsung SDI Co., Ltd., Yongin-si, Gyeonggi-do (KR)

(21) Appl. No.: 14/404,816

(22) PCT Filed: May 27, 2013
(86) PCT No.: PCT/EP2013/060850

§ 371 Date: Dec. 1, 2014

(30) Foreign Application Priority Data
Jun. 1, 2012 (DE) 10 2012 209 306.0

(51) Int. Cl. H01M 10/663; H01M 10/613; H01M 10/625; H01M 10/63

(52) U.S. Cl. CPC H01M 10/5095; H01M 10/502; H01M 10/5004; H01M 10/5016; H01M 2220/20

(57) ABSTRACT

A cooling system for battery cells includes a housing that surrounds battery cells of a battery pack and an external cooling system. One side of the housing is connected to and configured to thermally interact with the external cooling system. The external cooling system is configured to enable a coolant to pass therethrough. The cooling system and the battery pack are arranged and configured such that the coolant cannot enter the housing even in the event of a leak.

The present invention relates to a cooling system for battery cells, in particular for battery cells of a battery module having a plurality of battery cells.

### STATE OF THE ART

It is becoming apparent that in future new battery systems, on which very high demands are placed with regard to reliability, safety, performance and service life, will be increasingly used both in stationary applications, for example wind power stations, in vehicles, for example hybrid or electric vehicles, and in the consumer sector, for example in laptops or mobile phones.

In order to ensure the safety and functioning, particularly in the case of lithium-ion battery packs, it is necessary to operate the cells within a predefined temperature range. During operation of the cells heat is generated, especially in the form of the Joule effect, which can be described by the electric current and the internal resistance of the cell. Heat is also generated due to reversible processes in the cell. This generated heat must be dissipated, in order to prevent heating of the cell beyond a critical operating temperature. The use of a thermal management system for lithium-ion battery packs is therefore also known. This is usually designed using load cycles to predict the increase in temperature inside the battery, given known thermal constraints.

In order to operate the battery in optimum temperature ranges, cells are connected to a thermal management system. This heats the cells when they are still below a desired temperature, for example after starting on cold days, or cools the cells, especially during normal operation. A known technique here is to control the temperature of the cells or the cell modules via the underside of the cells. For this purpose, for example, the modules are mounted on plates with a fluid flow passing through them, to which water/glycol mixtures or evaporating refrigerants are admitted according to the required cooling performance.

In modern vehicles air-conditioning systems are often provided, which like the battery cooling system operate with liquid refrigerant. These are generally special refrigerants, however, not water-glycol mixtures. They sometimes have unwanted characteristics and on combustion may produce unwanted hydrogen fluoride compounds.

### DISCLOSURE OF THE INVENTION

According to the invention a temperature control system for a battery or a battery module is proposed, which comprises a heat carrier in order to dissipate the waste heat from the battery during cooling. This temperature control system is advantageously combined with an existing air conditioning system in modern cars. Here this refrigerant-based air conditioning system is advantageously modified so that problems with leakage are avoided. Due to numerous coupling or connecting elements in the pipeline carrying the refrigerant or possible damage to the thin-walled components, refrigerant circuits cannot be sealed 100%, for which reason air conditioning systems must be regularly serviced.

In order that such an air conditioning system can be operated with an inflammable coolant and at the same time operated for the cooling of batteries, including the associated power electronics together with the required connections, which can become hot in operation, special measures must be taken to allow an advantageous, safe and reliable battery cooling. Here it is particularly advantageous that these measures reliably prevent flammable gases being able to collect at a point in the cooling system, irrespective of the coolant used.

A substantial advantage of the invention, therefore, is that it affords a facility for allowing battery cell cooling by means of an expanded refrigerant circuit of the air conditioning system, without giving rise to the problems described in the state of the art.

This advantage is advantageously achieved in that the cooling elements are fitted outside the battery housing. Here the battery cells and/or the battery itself stand on a heat-conducting material. In an advantageous development this heat-conducting material at the same time serves as housing wall.

In another advantageous development the cooling elements at fitted to the external side of this housing wall. This means that the cells are then temperature-controlled by the housing wall. Since the cooling system in all developments according to the invention is situated outside the battery system, any coolant escaping can volatilize into the surrounding air and it is advantageously possible to preclude the formation of accumulations of gas from the coolant inside the battery pack.

If the air conditioning system is advantageously used to cool the batteries, the energy consumption for cooling the battery and the driver's cockpit is advantageously reduced.

### DRAWING

FIG. 1 represents a possible way in which cell cooling can, in principle, be coupled to the air conditioning unit of an air conditioning system. Three exemplary embodiments of the invention are represented in FIGS. 2 to 4. In detail, these show:

FIG. 2: an exemplary embodiment with externally fitted thermal management element and a housing of heat-conducting material,

FIG. 3: an exemplary embodiment of a variant with moisture barrier, in which the thermal element or thermal management element is formed as part of the housing and

FIG. 4: an exemplary embodiment in which the thermal element is formed as part of the housing with feed and return connection from outside.

The three exemplary embodiments allow the cooling system of the air conditioning system to be filled with a typical coolant for air conditioning systems and to be used for temperature control of the battery cells, wherein no coolant flows through the battery pack.

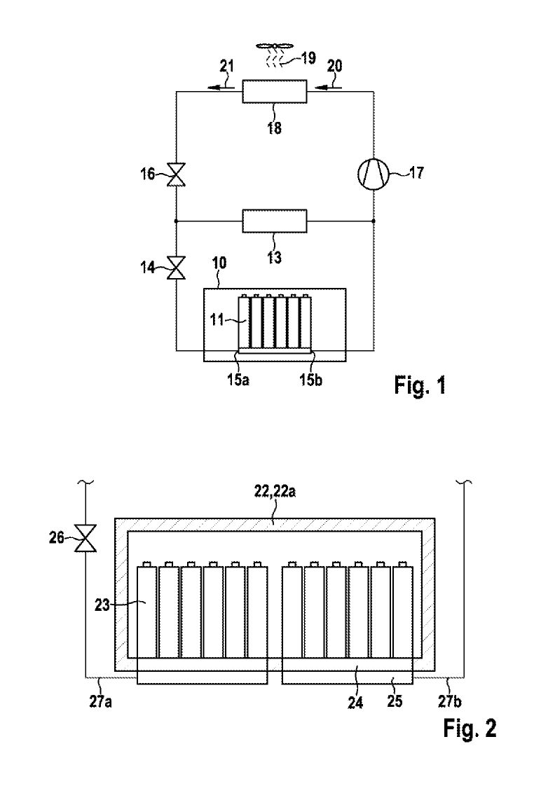

FIG. 1 represents one possible way in which cell cooling can be connected to the air conditioning unit of an air conditioning system. The cell cooling of a battery used in a vehicle can thereby be coupled to the cooling system of the air condition system of the vehicle.

In detail, 10 denotes a battery pack, which comprises multiple cells 11 on a cooling plate 12. The cooling system further comprises a heat exchanger 13, for example an evaporator with connection to the interior cooling, a regulating valve 14 between the heat exchanger 13 and the cooling plate connection 15a together with a regulating valve 16, a pump 17, a heat exchanger 18, which functions as condenser and a fan 19, which delivers a flow of air to the heat exchanger 18. The two arrows 20 and 21 denote the inlet to the heat exchanger 18 and the outlet from the heat exchanger 18 respectively. They also illustrate the direction of flow of the coolant in the system as a whole.

In the cooling system represented in FIG. 1 the same cooling is located inside the battery pack 10 and gases can escape from the cooling plate connection 15a or 15b. According to the invention, therefore, the cooling system represented in FIG. 1 is modified according to the exemplary embodiments in FIGS. 2 to 4. Where necessary, regulating and restriction valves are of controllable design.

FIG. 2 represents a first exemplary embodiment of the invention in which the cell cooling system is installed outside the battery housing. In detail, FIG. 2 shows a battery pack 22 having a housing 22a, together with the cells 23, which are at least thermally connected to the cooling plates 25 via a heat-conducting zone 24 of the housing 22a. The only other part of the cooling system shown is a restriction valve 26. The further arrangement of the cooling system corresponds to the cooling system arrangement represented in FIG. 1.

According to the exemplary embodiment in FIG. 2 the thermal management component or the thermal management element is fitted externally. The housing is composed of heat-conducting material. At least one part of the housing is a heat-conducting zone. In this arrangement the cell cooling system is installed outside the battery housing. The battery housing itself is heat-conducting at least in the area in which the cell modules are placed. The battery cells are mounted on the heat-conducting zones and can thus conduct the heat outwards. The zones are composed, preferably throughout, of a material having a high conductivity, for example a thin copper coating. The thickness of this zone may differ from the remaining housing wall thicknesses, in order to minimize the total thickness of the heat-conducting zones plus cooling plate.

The cooling pipes 27a and 27b run only outside the battery housing or along the outside of the battery housing. The cooling plates 25 are fixed on the outside of the heat-conducting zone 24. In the event of leaks, especially in the cooling pipes 27a or 27b, the coolant escapes outside the battery pack, that is to say outside the battery pack 22 and can volatilize in the surrounding air. This ensures that no coolant flows through the battery pack 22 or the housing 22a or is able to get into the battery pack or the housing.

Alternatively the entire housing may be built from heat-conducting material.

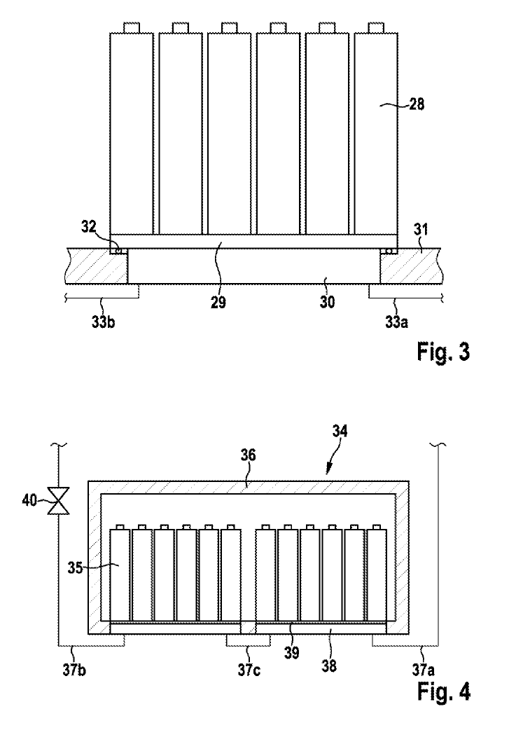

FIG. 3 represents a further exemplary embodiment of the invention. In this exemplary embodiment the cells are connected to a cooling plate 30 by way of a heat-conducting moisture barrier 29. The cooling plate 30 is integrated into the housing 31. A seal 32 lies in a groove of the housing 31 and seals off the entire system. The inlet 33a and outlet 33b are situated outside the housing 31.

In the solution according to FIG. 3 the cooling plate 30, as an evaporator plate or as a cooling plate 30, for example, with a flow of cooling medium flowing through it, is an external part of the housing 31. The housing 31 is sealed off from the outside by a sealing layer 29 in the form of a heat-conducting gas barrier or moisture barrier 29. This sealing layer 29 has a compressive strength which withstands the operating pressure throughout the service life. The cooling plate 30 is fitted into the housing 31 in modular form and is externally connected to the cooling system, for example the cooling system of a vehicle.

A further embodiment of the invention is depicted in FIG. 4. This shows a battery pack 34 with the battery cells 35, in which the cooling plate is an integral part of the housing 36. Here the cooling plate or a corresponding heat-conducting zone 38 is welded or tightly bonded into the housing 36, for example, and does not require further sealing. Here too, the connections for the cooling system 37a and 37b lie outside housing. The flow of coolant can be influences by means of a restriction valve 40 or a controllable regulating valve.

If multiple heat-conducting zones 38 are provided, as is shown in FIG. 4, a seal 39 is provided between the heat-conducting zones. A connection 37c then needed between the two heat-conducting zones in this case also lies outside the housing 36.

The housing 35 may be made from a composite material, for example. High-load carrying parts such as the cooling plate is made of metal, the remaining locations with cover and side wall are where necessary made of plastic or similar material, which allows a similar construction and a reduction in weight. The base plate, which comprises the cooling plates and remaining plastic plates may be produced in one go by means of a plastic injection molding method or a comparable method. An extra seal is then not required.

With the embodiments referred to above the heat-conducting plate/cooling plate or cooling plates and the cells or corresponding cell modules can be preassembled as an assembly unit. This allows a flexible assembly order, in which the insulating plate is first fitted into a housing, which comprises the cells. The cooling plate is inserted into an opening of the housing. Depending on the overall space taken up by the battery components, assembly may also be performed in reverse order, thereby greatly facilitating assembly of the battery pack.

Furthermore the cooling plate can be fitted from below, making it easy to change the cooling plate, which is easy to maintain, since when replacing it is not necessary to open the housing of the battery pack. This affords an especially advantageous solution using standardized cooling plates with various cooling media, for example air, cooling water, refrigerant etc. It is possible to adapt the thermal management system with cooling plates for retrofitting to the existing battery. This allows a change from water cooling to refrigerant cooling, for example.

A further development is a cooling system, in which the external cooling system is a “stand-alone” cooling system confined to the battery. This avoids having purposely to convert the coupling to the vehicle air conditioning system.

1. A cooling system for at least one battery cell comprising:
a cooling device that includes cooling elements configured to enable coolant to flow therethrough, and that is assigned to at least the one battery cell; and
an external cooling system that contains coolant and that is connected to the cooling device such that the coolant contained in the external cooling system is fluidically isolated from the battery cell even in the event of a fault.

2. The cooling system as claimed in claim 1, wherein the cooling device assigned to at least the one battery cell comprises a heat-conducting zone to which the cooling elements are assigned.

3. The cooling system as claimed in claim 2, further comprising a cooling plate, which is connected to the external cooling system and configured to enable the coolant to flow therethrough, and which is assigned to the heat-conducting zone.

4. The cooling system as claimed in claim 1, further comprising a housing that encloses the at least one battery cell.

5. The cooling system as claimed in claim 1, further comprising:
multiple battery cells which form a battery pack or a battery, and
a common housing that encloses the battery pack or the battery.

6. The cooling system as claimed in claim 5, wherein one respective side of each of the multiple battery cells is assigned to the heat-conducting zone of the cooling system.

7. The cooling system as claimed in claim 5, wherein the common housing comprises a heat-conducting zone.

8. The cooling system as claimed in claim 4, wherein the cooling elements are positioned outside the housing.

9. The cooling system as claimed in claim 1, wherein the external cooling system is the cooling system of a motor vehicle.

10. The cooling system as claimed in claim 9, wherein:
the cooling system of the motor vehicle is cooled via an air conditioning system, and
the air conditioning system is configured to cool the at least one battery cell.

11. The cooling system as claimed in claim 1, wherein the cooling device assigned to the at least one battery cell comprises a thermal element to which the cooling elements are assigned, wherein the thermal element forms a part of the housing and is assigned to the at least one battery cell.

12. The cooling system as claimed in claim 4, wherein the cooling device includes a feed connection and a return connection which are positioned outside the housing.

13. The cooling system as claimed in claim 1, wherein the external cooling system is configured to operate as a “stand-alone” cooling system confined to the battery when the cooling system is not coupled to a vehicle air conditioning system.
